(19) United States
(12) Patent Application Publication
(10) Pub. No.: US 2014/0356881 A1
(43) Pub. Date: Dec. 4, 2014

(54) INSPECTION INSTRUMENT, INSPECTION SYSTEM, AND INSPECTION METHOD

(71) Applicant: CANON KABUSHIKI KAISHA, Tokyo (JP)

(72) Inventor: Shuya Satoh, Yokohama-shi (JP)

(73) Assignee: CANON KABUSHIKI KAISHA, Tokyo (JP)

(21) Appl. No.: 14/290,840

(22) Filed: May 29, 2014

(30) Foreign Application Priority Data
May 31, 2013 (JP) 2013-115684

(51) Int. Cl. G01N 21/65; G01J 3/44

(52) U.S. Cl. CPC G01N 21/65; G01J 3/4412
USPC 435/7.1; 356/301; 356/51

(57) ABSTRACT

With an inspection instrument in which an optical window is disposed so as to enable optical detection in a sample holder, an analysis involving use of a three-order nonlinear Raman scattering microscope, a treatment with an agent, such as staining, and an analysis involving use of a normal optical microscope are serially carried out without opening and closing of the inspection instrument. Thus, in addition to reference information based on result of analysis of a stained sample, more multiple pieces of auxiliary information related to the morphological or functional characteristics of the sample can be obtained from the sample while the reliability of comparison thereof with the reference information is well maintained.

### BACKGROUND OF THE INVENTION

1. Field of the Invention

The present invention relates to an inspection instrument which is used for holding a sample and treating the sample with an agent for optical observation; the present invention also relates to an inspection method in which such an inspection instrument is used.

2. Description of the Related Art

In hospital facilities and research institutes, vital observation is widely carried out with, for example, naked eyes, optical microscopes, and electron microscopes. In particular, in pathological diagnosis that is known as an important medical practice, a specimen obtained from a patient suspected of having a cancerous tumor, precancerous lesion, or another disease is observed with a microscope to determine the presence or absence, type, or condition of the lesion.

A preparation used for pathological diagnosis is produced by placing a specimen, such as a section of a tissue or a cell, on a slide glass; staining the specimen; and covering the resulting specimen with a mounting medium and cover glass. The staining is carried out to help an observer to find the morphological characteristics or functional characteristics of the specimen; for instance, hematoxylin eosin staining (HE staining) and Papanicolaou staining are widely used as standard staining techniques in histological diagnosis and cytological diagnosis, respectively. Furthermore, in order to additionally obtain auxiliary information necessary for diagnosis, other staining techniques, such as a special staining procedure and an immunohistochemical staining procedure, and a variety of instrumental analyses are employed in some cases.

Information obtained by a standard staining technique is hereinafter referred to as “reference information”; in pathological diagnosis, a variety of auxiliary information is used to be compared with reference information in many cases. In general, since a single preparation used for a pathological diagnosis is produced by one staining technique, such comparison of information (information comparison) is carried out by comparing pieces of information obtained from separate preparations with each other. Morphological and functional homology between preparations is important for accurate information comparison; hence, in histological diagnosis, auxiliary information is obtained from two or more different sections taken from parts of one specimen which are adjacent to or in the vicinity of each other in many cases. However, in the case where multiple pieces of auxiliary information are obtained by various staining techniques to satisfy the requirements of subdivided or highly precise classification of diseases, the number of necessary precipitations increases, which problematically leads to increases in costs and workloads for producing the precipitations. In addition, as parts of a specimen from which individual precipitations have been taken are distant from each other, morphological and functional homology between the precipitations is reduced with the result that the reliability of information comparison becomes more likely to be reduced, which is critically more problematic. Hence, a technique which enables multiple pieces of auxiliary information to be obtained from preparations while the reliability of comparison of the auxiliary information with reference information is maintained has been demanded.

Multiple immunohistochemical staining has been studied as a technique that further enables multiple pieces of auxiliary information to be obtained. For instance, in an example disclosed in “Byouri to Rinshou; vol. 14; 1996; p. 1533-1536”, the following three processes are repeated to sequentially stain three antigens in one preparation: a process for binding an antigen to an antibody, a process for developing color from the antigen location through an enzyme reaction, and a process for deactivating the antigenicity of the antibody by heating.

Furthermore, a technique for improving the reliability of comparison of auxiliary information with reference information has been studied, in which staining and destaining are combined to carry out multiple staining procedures in one preparation. In Japanese Patent Laid-Open No. 7-27682, for example, a technique for producing a cytological preparation has been proposed, in which first staining with a fluorescent dye, removal of the fluorescent dye with alcohol, and second staining by Papanicolaou staining are carried out in one preparation to sequentially perform DNA quantitation and morphological observation of a target cell.

A technique for observing a preparation without staining has been also studied as another technique that further enables multiple pieces of auxiliary information to be obtained. In a technique disclosed in “Nature Photonics; 6; 2012; 845-851”, an image is reproduced from information obtained in measurement of a non-stained preparation with a stimulated Raman scattering microscope. Stimulated Raman scattering is one of third-order nonlinear optical effects; in this phenomenon, two light beams having different wavelengths interact with the molecular vibration of molecules, and the energy of the light beam having a shorter wavelength shifts to the light beam having the longer wavelength when the difference in frequency between the light beams corresponds to the frequency of the molecular vibration. With a stimulated Raman scattering microscope, the information of molecular vibration which indicates a substance contained in a preparation can be detected and used as a drawing contrast, which enables reproduction of an image reflecting the morphology of the preparation and a variety of information of the composition thereof without a staining process.

Even those techniques, however, have been still insufficient to satisfy requirements for both obtaining multiple pieces of auxiliary information and maintaining the reliability of comparison thereof with reference information.

In the technique disclosed in “Byouri to Rinshou; vol. 14; 1996; p. 1533-1536”, no more than several pieces of auxiliary information can be obtained from one preparation. This is because the types of substances which can be stained by immunohistochemical staining for visualization in one preparation are limited by, for instance, the types of enzyme reactions for color development, the types of an antibody labeling dyes, and the number of antibody-producing animal species. Moreover, in the case where immunohistochemical staining and normal staining are carried out in one preparation, it is difficult to distinguish results of the staining from each other, which may cause a problem in comparison of auxiliary information with reference information based on the observation of the stained preparation.

The technique disclosed in Japanese Patent Laid-Open No. 7-27682 or “Nature Photonics; 6; 2012; 845-851” enables multiple pieces of auxiliary information to be relatively easily obtained and is therefore good in this regard; however, in order to compare the auxiliary information with reference information based on staining, the staining and optical observation need to be sequentially carried out. In this case, placement and removal of cover glass and exposure to a reagent solution are likely to cause partial loss of a preparation and deformation thereof, which leads to a problem in comparison of the obtained auxiliary information with reference information based on observation of the stained preparation.

### SUMMARY OF THE INVENTION

A first aspect of the present invention provides an inspection instrument including a sample holder which serves to hold a sample and an optical window which serves as part of the sample holder, wherein at least part of the optical window serves as a substance-permeable membrane.

A second aspect of the present invention provides an inspection method for inspecting a sample with such an inspection instrument, the method including a step for feeding an aqueous solution containing an agent from the outside of the sample holder to bring the agent into contact with a sample held in the sample holder via the substance-permeable membrane and a step for optically observing the sample.

According to some aspects of the present invention, a specimen held in the inspection instrument can be easily and serially subjected to a treatment with an agent, such as staining, and optical observation without opening and closing of the inspection instrument. Thus, in addition to reference information based on observation of a stained preparation, more multiple pieces of auxiliary information related to the morphological or functional characteristics of the preparation can be obtained from the preparation while the reliability of comparison thereof with the reference information is well maintained.

Further features of the present invention will become apparent from the following description of exemplary embodiments with reference to the attached drawings.

### BRIEF DESCRIPTION OF THE DRAWINGS

FIG. 1 is a cross-sectional side view illustrating an inspection instrument having optical windows, used for a transmissive optical analysis, and disposed in an optical system.

FIG. 2 is a cross-sectional side view illustrating an inspection instrument having an optical window, used for a reflective optical analysis, and disposed in an optical system.

FIG. 3 illustrates examples of a process of optical observation; A indicates a process for obtaining auxiliary information by analysis without staining and then obtaining reference information based on staining, B indicates a process for obtaining reference information based on staining and then obtaining auxiliary information by analysis without staining, and C indicates a process for obtaining reference information based on staining and then obtaining auxiliary information based on another staining.

FIG. 4 schematically illustrates an inspection system.

FIG. 5 is a block diagram illustrating the general structures of the inspection instrument and a stimulated Raman scattering microscope.

### DESCRIPTION OF THE EMBODIMENTS

Embodiments of the present invention will now be described in detail with reference to the accompanying drawings. The embodiments described below are examples of the best mode of the present invention, and the present invention should not be limited to these specific embodiments.

### First Embodiment

### Embodiment of Inspection Instrument

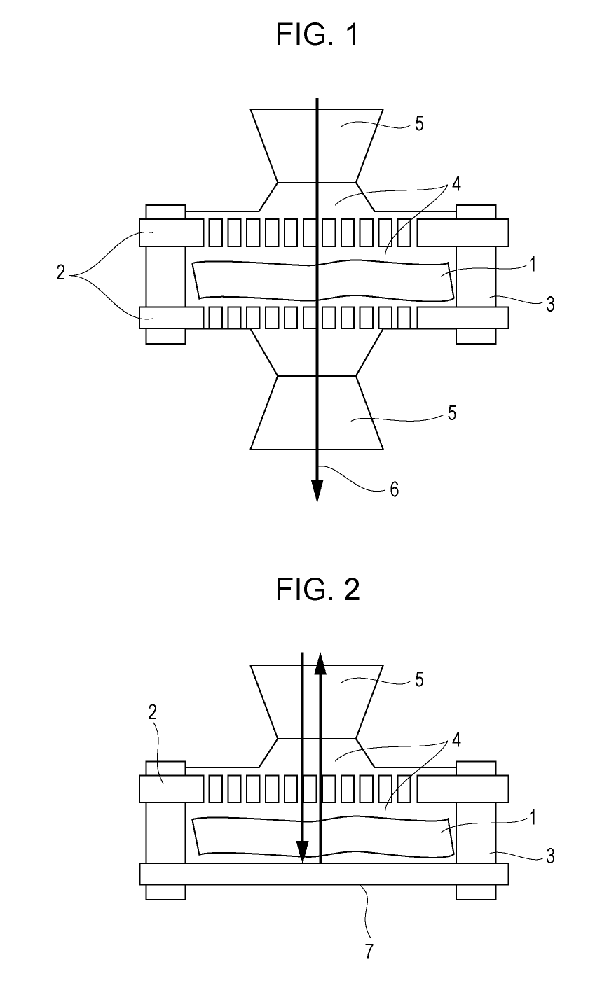

FIGS. 1 and 2 are schematic cross-sectional views illustrating inspection instruments of the first embodiment in a state in which the inspection instruments have been disposed in optical systems. In particular, FIG. 1 illustrates a structure employed for transmissive optical observation, in which two optical windows are disposed so as to face each other with a sample interposed therebetween. In other words, viewed from a light source, optical windows 2 which are the above-mentioned windows are positioned such that the optical axis 6 of light emitted for optical detection or imaging intersects the optical windows 2 on both the light-source side and the opposite side with a sample 1 interposed therebetween.

The optical windows 2 may be independent two members or may be a single curved member or part of a member that is in the form of a cylinder or bag.

The inspection instrument having a structure illustrated in FIG. 1 can be used for reflective observation; however, a structure illustrated in FIG. 2 is more suitable for reflective observation. In particular, viewed from a light source, an optical window 2 is disposed such that the optical axis 6 of light emitted for optical detection or imaging intersects the optical window 2 on the light-source side relative to the sample 1, and a reflecting layer 7 is disposed on the side opposite to the light-source side with the sample 1 interposed therebetween. This structure enables improvement of signal sensitivity in so-called post-detection, so that signals can be easily converted into images.

In the case where observation is carried out with a third-order nonlinear Raman scattering microscope, the reflective layer 7 may be a near-infrared-light-reflecting layer.

Also in this case, the optical window 2 may be a single curved member or part of a member that is in the form of a cylinder or bag.

Each structure may have an optical-window-supporting member 3 that enables the thin optical window 2 to be easily handled. In this case, the shape of the optical-window-supporting member 3 needs to be appropriately determined as needed, and the shape that allows the curvature of the optical window 2 to be kept small is desirable in terms of a reduction in aberration. In addition, a fluid 4 can be placed in a gap between the sample 1 and each of the optical windows 2 and in a gap between each of the optical windows 2 and each of objective lenses 5 to adjust the refractive index, which enables intended observation without generation of a problem of aberration even when the optical windows 2 have a large curvature.

In the first embodiment of the present invention, the optical window 2 can also function as a substance-permeable membrane, and an agent can be therefore fed from the outside of a sample holder without opening and closing of the inspection instrument and act on a biological sample held in the sample holder. In production of a preparation used for pathological diagnosis, an agent is used in the form of an aqueous solution for staining of a sample or a biochemical reaction thereof in many cases; hence, the substance-permeable member is desirably hydrophilic. Since an organic solvent such as alcohol is used to, for example, remove a nonspecific adsorbed dye in some staining techniques, a substance-permeable membrane having a solvent resistance can be used further in general treatments.

A variety of porous membranes can be used as a substance-permeable membrane. In general, the less a porous membrane is dense, the better an agent spreads, which enables, for example, a reduction in time taken in a staining process or destaining process. In the case where the pore size is in an order of greater than or equal to a micron, a sample itself, a small piece of the sample, and the nano-structured materials contained in the sample are more likely to leak to the outside of the sample holder. In the case where the pore size is unnecessarily large, light scattering may cause troubles in a stimulated Raman analysis and an analysis with a general optical microscope, and thus such a pore size is inappropriate. It is desirable that the substance-permeable membrane used in the first embodiment allow an agent to promptly pass through it while a fine piece derived from a sample is not allowed to pass through it and that the substance-permeable membrane do not cause significant light scattering. In production of a preparation used for pathological diagnosis, the molecular weight of a dye used in standard staining is not more than 1000, and, for example, the molecular weight of an antibody used in specific immunohistochemical staining is approximately from tens of thousands to hundreds of thousands. In general, the idea of “molecular weight cut-off” is often utilized to explain the performance of a substance-permeable membrane and gives a value showing the upper limit of the molecular weight of the substance that can pass through a membrane; according to this idea, the molecular weight cut-off of the porous membrane used in the first embodiment of the present invention can be in the range of 1000 to 1000000. Furthermore, in terms of an average pore size, the average pore size of the porous membrane is preferably in the range of 1 nm to 0.2 μm, and more preferably 1 nm to 0.1 μm.

The thickness of the substance-permeable membrane used in the first embodiment is not limited provided that the substance-permeable membrane has a substance permeability that enables the feeding of an agent and a light transmittance optimum for observation; however, the thickness ranging from 1 μm to 1 mm enables a porous membrane having the above-mentioned properties to be flexibly selected and therefore can be employed.

The optical window 2 needs to transmit light that is in a wavelength region proper for an observation process to which the inspection instrument is applied; in observation of a biological preparation, light that is in a wavelength region from visible light to near-infrared light is used in many cases, and thus light that is particularly in such a wavelength region is properly transmitted. In general, the wavelength region of visible light is approximately in the range of 380 nm to 750 nm, and the wavelength region of near-infrared light is approximately in the range of 750 nm to 2500 nm. In the case where part of a sample which is deeper than the surface thereof is observed in a biological analysis, light that is in a wavelength region from visible light to near-infrared light of 700 nm to 1400 nm is used in many cases because an effect of absorption by water molecules on such light is relatively small. Hence, the material used for the optical window 2 may be a material which is highly transmissive, at least in a wet state, to light that is in a wavelength region from visible light to near-infrared light; in particular, a material that greatly transmits light having a wavelength ranging from 380 nm to 1400 nm in a wet state may be employed.

The term “wet state” herein refers to a state in which moisture is contained in the membrane and can be quantitatively represented by moisture content (=amount of moisture held in membrane/total weight of membrane). The moisture content of the membrane is preferably not less than 5%, and more preferably not less than 25%.

Examples of a material suitably used for the optical window 2 in the first embodiment of the present invention include organic polymer materials such as nitrocellulose, cellulose acetate, hydrophilic fluororesin, and polycarbonate, and these materials can be used alone or in combination.

Commercially available porous membranes each having a controlled pore size can be used as the above-mentioned materials. A porous membrane having the above-mentioned properties may be appropriately selected and used as the optical window 2 in the first embodiment of the present invention.

Another structure may be employed, in which the elasticity of the porous membrane is utilized to bring the membrane into contact with a sample for fixing the sample. In this case, since the sample is in contact with the porous membrane, a reagent can be further effectively fed through the membrane.

Since the optical window 2 of the first embodiment of the present invention can transmit light that is in a wavelength region from visible light to near-infrared light, a variety of light sources can be flexibly selected, which enables multiple pieces of information to be easily obtained with various analytical apparatuses.

For instance, detection of fluorescence, detection of phosphorescence, and analysis of Raman scattering, which are each owing to excitation with visible light or near-infrared light, and formation of a general optical image reflecting the absorption spectrum of a dye can be easily carried out with one inspection instrument.

### Second Embodiment

Inspection Method with Inspection Instrument

An inspection method according to the second embodiment of the present invention includes a step for feeding an aqueous solution containing an agent from the outside of the sample holder to bring the agent into contact with a sample held in the sample holder via the substance-permeable membrane and a step for optically observing the sample.

In the step of the optical observation, a third-order nonlinear Raman scattering microscope can be used; in particular, the Raman scattering microscope can be a stimulated Raman scattering microscope. The observation step also involves dividing a region that is to be observed into two-dimensional pixel areas and obtaining two-dimensional image information having spectral information in the form of digital information in the individual pixels.

The agent can be a dye, and the sample can be optically observed in different manners before and after the dye is brought into contact with the sample.

In particular, the observation can be carried out with a third-order nonlinear Raman scattering microscope, a dye can be brought into contact with the sample after the observation, and the sample stained with the dye can be optically observed after the dye is brought into contact with the sample.

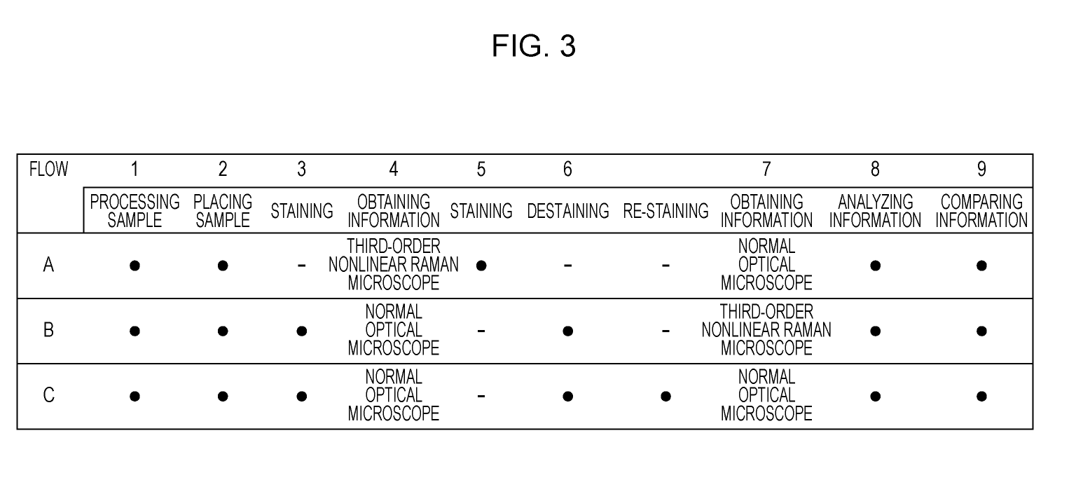

FIG. 3 illustrates specific examples of the inspection method of the second embodiment of the present invention; in particular, FIG. 3 illustrates flows for serially performing the following processes without opening and closing of the inspection instrument: an analysis for obtaining the auxiliary information of a specimen held in the inspection instrument; a treatment with an agent, such as staining; and an analysis for obtaining reference information with an optical microscope.

A biological sample is formed into an appropriate shape such as a section, and the resulting sample is placed in the inspection instrument. Then, Flow A can be employed; auxiliary information is obtained from the sample with a three-order nonlinear Raman scattering microscope without staining the sample, the sample is subsequently stained via the substance-permeable membrane without opening and closing of the inspection instrument, and then reference information is obtained with a normal optical microscope.

Furthermore, Flow B can be employed; the sample is stained via the substance-permeable membrane, reference information is obtained with a normal optical microscope, an appropriate destaining reagent is allowed to act on the sample to remove the dye without opening and closing of the inspection instrument, and then auxiliary information is obtained from the sample with a third-dimensional nonlinear Raman scattering microscope.

Moreover, Flow C can be employed; the sample is stained via the substance-permeable membrane, reference information is obtained with a normal optical microscope, an appropriate destaining reagent is allowed to act on the sample to remove the dye without opening and closing of the inspection instrument, a staining treatment such as special staining procedure is subsequently carried out, and then auxiliary information is obtained from the sample with a normal optical microscope.

Examples of destaining reagents usable in these flows include, provided that the destaining agents do not cause the significant morphological change of a preparation, hypochlorous acid solution, hydrogen peroxide solution, and organic solvents such as an alcohol. Furthermore, provided that a dye does not prevent the analysis of signals with a three-order nonlinear Raman microscope, the destaining process may be eliminated, or a specific staining that is helpful in the Raman analysis may be employed.

In addition to the staining agent and the destaining agent, an appropriate biologically active agent which can be bonded to a substance contained in a sample can be used as the agent that is allowed to act on the sample. Signals detected with a three-order nonlinear Raman scattering microscope can be directly used as a drawing contrast and reproduced into an image that is to be shown and also can be used to show result of analysis of combined pieces of information in multiple analytical wavelengths. Furthermore, reference information and auxiliary information can be combined by use of a signal processor and integrally shown, which gives an effect in which users can easily compare the information.

### Third Embodiment

### Sample Inspection System Including Inspection Instrument

A sample inspection system which enables the inspection method of the second embodiment will now be described.

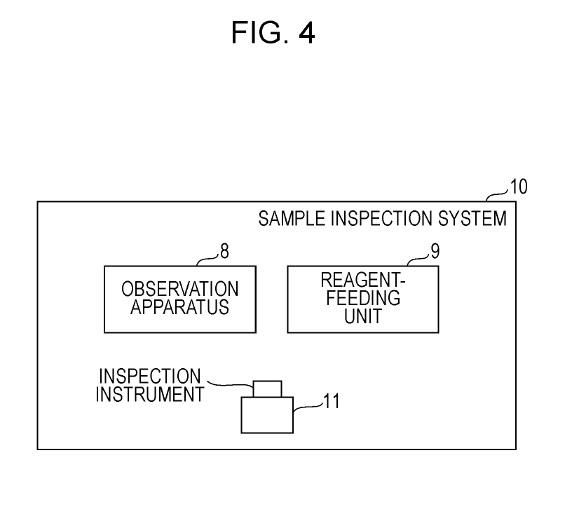

FIG. 4 schematically illustrates the structure of a sample inspection system according to the third embodiment.

A sample inspection system 10 includes an observation apparatus 8, a reagent-feeding unit 9, and an inspection instrument holder 11. The inspection instrument holder 11 serves to hold the inspection instrument when a sample is observed with the observation apparatus 8 and when a reagent is fed from the reagent-feeding unit 9 to the sample and may be disposed on a moving stage to enable the inspection instrument to move inside the system.

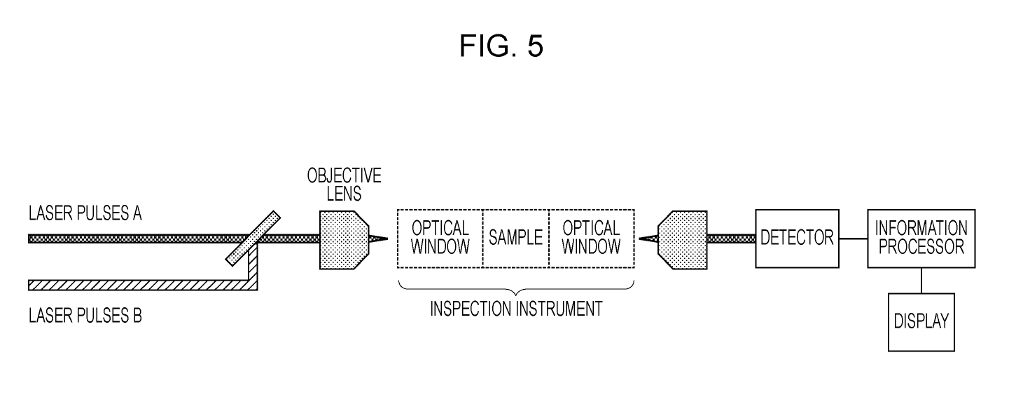

FIG. 5 illustrates the structure of the observation apparatus 8 in detail.

In the third embodiment, the biological sample 1 held in the sample holder of the inspection instrument including the optical windows 2 and the optical window-supporting member 3 is analyzed in a confocal optical system. Two laser beams having different wavelengths are focused inside the sample through an objective lens. In a third-order nonlinear Raman scattering microscope, optical signals which reflect Raman scattering generated in the focal position pass through the other objective lens which is disposed so as to face the above-mentioned objective lens, and the optical signals are obtained with a detector. Then, a spectral analysis and image reproduction are carried out in a signal processor, and a display shows users information.

In typically known Raman spectroscopy, nonlinear Raman scattered light emitted from a sample irradiated with a laser beam is dispersed. A system for forming an image of a biological tissue without staining has been proposed, to which the above-mentioned Raman spectroscopy is applied and which are based on, for example, stimulated Raman scattering, hyper Raman scattering, or coherent anti-stokes Raman scattering (CARS). Use of such a system enables formation of an image of a non-stained tissue in principle; among third-order nonlinear Raman scattering microscopes, a stimulated Raman scattering microscope particularly has advantages of being highly sensitive and providing molecular information at a high S/N ratio and therefore can be appropriately used. The stimulated Raman scattering microscope enables quick observation, and this characteristic of the stimulated Raman scattering microscope is advantageous, for instance, in analysis and imaging of the structure of a tissue derived from a biological object.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-115684, filed May 31, 2013, which is hereby incorporated by reference herein in its entirety.

What is claimed is:

1. An inspection instrument comprising:
a sample holder which serves to hold a sample; and
an optical window which serves as part of the sample holder, wherein
at least part of the optical window serves as a substance-permeable membrane.

2. The inspection instrument according to claim 1, wherein the substance-permeable membrane is a porous membrane.

3. The inspection instrument according to claim 1, wherein the molecular weight cut-off of the substance-permeable membrane is in the range of 1000 to 1000000.

4. The inspection instrument according to claim 1, wherein the average pore size of the substance-permeable membrane is in the range of 100 nm to 0.2 μm.

5. The inspection instrument according to claim 1, wherein the substance-permeable membrane is a porous membrane thorough which any one of a dye and biologically active agent having a molecular weight of not more than 1000000 passes.

6. The inspection instrument according to claim 1, wherein the optical window transmits light in a wavelength region from visible light to near-infrared light at least when the optical window is in a wet state.

7. The inspection instrument according to claim 1, wherein the optical window transmits light having a wavelength ranging from 380 nm to 1400 nm at least when the optical window is in a wet state.

8. The inspection instrument according to claim 1, further comprising an additional optical window disposed so as to face the optical window with the sample interposed between the two optical windows.

9. The inspection instrument according to claim 1, further comprising a reflective layer disposed so as to face the optical window with the sample interposed between the optical window and the reflective layer.

10. An inspection method for inspecting a sample with the inspection instrument according to claim 1, the method comprising:
a step for feeding an aqueous solution containing an agent from the outside of the sample holder to bring the agent into contact with a sample held in the sample holder via the substance-permeable membrane; and
a step for optically observing the sample.

11. The method according to claim 10, wherein the step for optical observation includes observation with a three-order nonlinear Raman scattering microscope.

12. The method according to claim 11, wherein the three-order nonlinear Raman scattering microscope is a stimulated Raman scattering microscope.

13. The method according to claim 10, wherein the agent is a dye, and the step for optically observing the sample is carried out before and after the step for bringing the dye into contact with the sample in different manners.

14. The method according to claim 13, wherein
the observation is carried out with a third-order nonlinear Raman scattering microscope,
the dye is brought into contact with the sample after the observation, and
the sample stained with the dye is optically observed after the dye is brought into contact with the sample.

15. A sample inspection system comprising:
the inspection instrument according to claim 1;
an inspection instrument holder that serves to hold the inspection instrument; and
an observation unit that serves to observe a sample held in the inspection instrument.

16. The system according to claim 15, further comprising an agent-feeding unit that serves to feed an agent to the sample.
